(19) United States
(12) Patent Application Publication
(10) Pub. No.: US 2013/0311402 A1
(43) Pub. Date: Nov. 21, 2013

(54) METHOD TO FINANCE DATA CENTERS AND OTHER HIGH INFRASTRUCTURE FACILITIES

(71) Applicant: BRUCE J. DEBOLT, Vista, CA (US)

(72) Inventor: BRUCE J. DEBOLT, Vista, CA (US)

(21) Appl. No.: 13/897,183

(22) Filed: May 17, 2013

Related U.S. Application Data
(60) Provisional application No. 61/649,149, filed on May 18, 2012.

(51) Int. Cl. G06Q 40/06; G06Q 50/08

(52) U.S. Cl. CPC G06Q 40/06; G06Q 50/08
USPC 705/36 T; 705/36 R

(57) ABSTRACT

A method to finance data centers and other high infrastructure facilities provides suitable collateral to close real estate financing. The method has three portions: vetting of suitable projects upon a computer, assembly of select tax credits upon a computer, and formation of capital as collateral for financing. This invention finds a building that fits the criteria for a government preservation program. Then the invention obtains collateral for financing the building renovation or rehabilitation from governmental agencies in connection with the building. Next the invention finds a third party interested in the collateral that invests in a building project or ownership of the building in exchange for the collateral. The investment funds then provide a down payment for the financing. The collateral may have the form of a federal tax credit. The method promotes financing of structures that may otherwise not obtain financing for reconstruction into a new use.

### CROSS-REFERENCE TO RELATED APPLICATION

This non-provisional application claims priority to the pending provisional application 61/649,148 filed on May 18, 2012 which is owned by the same inventor.

### BACKGROUND OF THE INVENTION

The method to finance data centers and other high infrastructure facilities generally relates to financing of real estate and more specifically to usage of select collateral.

As America underwent the industrial revolution, various factories, warehouse, and other structures appeared. The structures served the people who worked in them and the cities around them. For many decades those structures made various consumer products, stored materials, and served as headquarters for service providers. However, following World War II, commerce, especially manufacturing, began to leave the city cores across the country.

City cores presently have many hundreds of buildings covering hundreds of thousands of square feet, sitting there unused. Such buildings attract vandals and other undesirables and in time succumb to the elements. Such buildings quite often contribute little or nothing to the tax rolls in their cities. Such highly stressed buildings generally have a minimum of four walls and an open rectangle like form. Often, the highly stress buildings have a site in a low cost electrical grid.

From time to time, a developer has a concept to reuse a building. The building generally retains its footprint upon its parcel and its outer shell. However, the developer may completely rehabilitate the interior of a building. Select developers fund their projects through internal resources. However, many developers require financing of their projects through commercial loans from a bank or a group of banks. A developer may be an individual but is most likely a business entity such as corporation or a limited liability company.

For a commercial loan, a bank commits a portion of its deposits to a development project with the intent of the developer repaying the loan with interest as commonly done. To fulfill that intent, a bank seeks a project that has sufficient cash flow projections to cover the principal and interest payments of the loaned amount. Select developers, generally few in number, make such projections with financial confidence. Most developers though take on projects with a speculative nature making cash flow projections difficult. Because cash flow has such a difficult projection, banks generally avoid lending to developers on projects that lack an identified tenant where the tenant indicates the cash flow of a project through a stream of rental income to the developer. Though this description mentions developer, the Application also foresees landlord and like titles being used for an owner of property under development. Further, the 2008 financial crisis forced banks to reevaluate their existing loan portfolios and remove non-performing loans and to heighten scrutiny of applicants for new loans, including commercial loans.

Presently, much computing power and data storage has remote locations from users of the computing and storage. The users can be individuals or companies with various needs. The needs though continually call for more computing power and ever increasing storage of data. The data can be of all kinds: alpha numeric, word processing, spreadsheets, presentations, audio files, video files, movie files and the like. Computing and storage users generally have a growing and insatiable appetite for more computing power and more storage. Towards that end, various companies have small data centers and select companies, such as Apple, Inc., and various Internet trunk line operators, have started construction upon large data centers.

Similar to other real estate projects, data centers have their construction costs. Most developers of data centers require bank financing to bring about projects. Like other real estate projects, banks generally avoid lending to developers for data center construction without an identified tenant for a facility. Tenants usually delay a decision on occupying a facility, such as a data center, until after completion of the data center construction. The bank seeks to protect its repayment obligations to depositors while the developer seeks to meet a market need.

### DESCRIPTION OF THE PRIOR ART

Over the years, banks and developers have sought out financing methods for real estate projects. Early on, banks restricted larger commercial loans to larger developers generally known to the banks. A small bank may start with a small developer on a small project. Hopefully in time, the bank, developer, and projects mutually grow bigger. A larger bank or group of banks may request large developers apply for loans while overlooking small developers and small projects. Various state and federal regulators also have a role in the bank and loan applicant criteria.

Banks and developers have made various financing methods suitable for projects. Such methods include low payments during the life of a loan with a balloon payment as the last payment, payments tied to an index rate that may fluctuate over time, payments fixed for a certain time period and then allowed to float, and the like. In these various financing methods, the banks still often require collateral. The collateral allows a bank to evaluate a potential debtor, to screen out weak debtors, and to sensitize a debtor, that is, a developer, to complete a project, along with other reasons, some unique to particular banks. Various state and federal regulators also define and limit financing methods and collateral requirements through their regulations and oversight role. As above, the aftermath of the 2008 financial crisis has stimulated regulatory oversight of new financing methods and debtors at all levels.

The U.S. Pat. No. 6,292,788 to Roberts deals with real estate financing and 1031 exchanges. This financing method utilizes a master lease that controls and manages a portfolio of deedshares where the lease has real property as its subject. Third parties may own the deedshares without the obligation to maintain real property while meeting the requirements of 26 U.S.C. §1031 for select property exchanges.

The U.S. Pat. No. 8,341,072 to Ramsey deals with an MLP Financing System that extends the properties of shares in a publicly traded entity that does not generate unrelated business taxable income, or UBTI, to create a new asset class that permits the underlying assets to be specifically structured for financing.

The present invention overcomes the disadvantages of the prior art and provides a method to finance data centers and other high infrastructure facilities that applies to developers of all sizes and banks of all sizes.

### SUMMARY OF THE INVENTION

Generally, the method to finance data centers and other high infrastructure facilities funds the redevelopment of properties that otherwise would languish, many of which are in a high state of distress in urban environments. The method of the present invention twines together the various rehabilitation incentives creating a source of capital to underwrite the redevelopment and adaptive reuse costs for an economically viable and energy efficient data center, building, facility, or plant. The method of the invention provides financing through certain collateral that allows construction of a facility without an identified tenant.

The present invention has its method comprising three portions: vetting of suitable projects upon a computer, assembly of select tax credits upon a computer, and formation of capital as collateral for financing. The method of this invention finds a building that fits the criteria for a government preservation program. Then the invention obtains collateral for financing the building renovation or rehabilitation from a governmental agency in connection with the building. The collateral takes the form of various tax credits. Next the invention finds a third party interested in the collateral. The invention then has the third party invest in a project in exchange for the collateral, that is, the tax credits, and the invested funds then provide a down payment for the financing. The collateral may have the form of a state tax credit, a federal tax credit, or both. The tax credit may retire a bank loan or construction loan, or a bond. The present invention monetizes government rights, such as tax credits, into collateral.

There has thus been outlined, rather broadly, the more important features of the invention in order that the detailed description thereof that follows may be better understood and that the present contribution to the art may be better appreciated. The present invention also includes vetting of projects by computer and facilitating introductions and communications between the owners of a project and third parties interested in tax credits by computer. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a method to finance data centers and other high infrastructure facilities that creates collateral for construction financing without an identified tenant for a facility.

Another object is to provide such a method to finance data centers and other high infrastructure facilities that stimulates rehabilitation of historic old facilities.

Another object is to provide such a method to finance data centers and other high infrastructure facilities that verifies project qualification using computerized review of databases.

Another object is to provide such a method to finance data centers and other high infrastructure facilities that monetizes a government right, such as a tax credit, into collateral for financing.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 is flow chart of the present invention.

The same reference numerals refer to the same parts throughout the various figures.

### DESCRIPTION OF THE PREFERRED EMBODIMENT

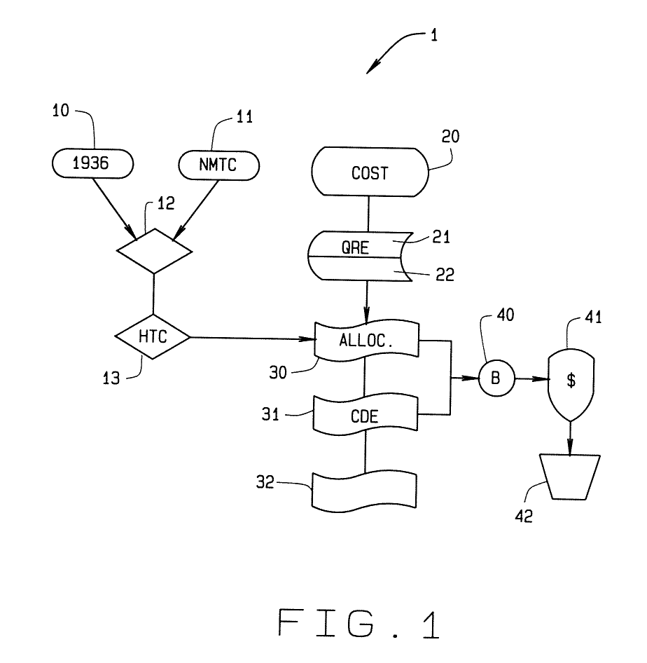

The present art overcomes the prior art limitations by providing a method to finance data centers and other high infrastructure facilities. A historic building may have many forms typically summarized as an open rectangle of four walls. Such buildings may be in older, city core areas and show their years with a run down look. However, various governmental entities seek to stimulate rehabilitation of historic buildings into new, modern uses. The method of the present invention acts upon that stimulus, creating a source of capital, and funding redevelopment of buildings from that source. FIG. 1 shows the flow of the present invention. The present invention utilizes the following components as shown in FIG. 1:
10 identifying buildings completed prior to 1936;
11 identifying buildings sited in new markets tax credit qualifying census tracts;
12 identifying buildings that meet both steps 1 and 2;
13 identifying buildings sited in States that have a historic tax credit or preservation program;
20 estimating the total project costs for rehabilitating a data center or a facility;
21 determining the qualifying rehabilitation expenses;
22 multiplying the qualifying rehabilitation expenses by twenty per cent and adding that amount to the qualifying rehabilitation expenses;
30 obtaining an allocation or a reservation of a State Historic Tax Credit if required by State statute at the project site;
31 obtaining a required allocation from a qualified community development enterprise as denoted by the Dept. of the Treasury;
32 cultivating additional capital contribution, if needed to obtain a tax increment financing loan;
40 identifying and admitting as a lessee, shareholder, or partner a third party investor of the required allocation before the “placed in service” date of a project in a manner that meets the requirements of 26 U.S.C. §47 and related rules and regulations;
41 directing the investor's funds into collateral; and,
42 arranging construction financing based upon that collateral.
   The present invention has its method comprising three portions: vetting of suitable projects upon a computer connected to a storage device holding instructions in the form of software, assembly of select tax credits upon a computer with its storage device and under its instructions, and formation of capital as collateral for financing. The computer and storage device may be connected upon a network. The first portion, vetting of suitable projects upon a computer, includes steps 10, 11, 12, 13, 20, 21, 22. The second portion of the invention, assembly of select tax credits upon a computer, has steps 30, 31, 32. The third portion of the invention, formation of capital leading to collateral for construction financing, has steps 40, 41, and 42. The description now proceeds to each step of the method.

The invention 1 begins with the step of identifying buildings completed prior to 1936 as at 10. This step occurs upon a computer reviewing property records in cities. The computer searches for date of building construction, date of addition to the tax rolls, date of first tax payment, and the like showing a date before 1936. Next, as at 11, the invention identifies buildings sited in new markets tax credit qualifying census tracts. A computer programmed with census tract location data then identifies buildings in that tract by address, or parcel number. The invention then identifies building addresses, as at 12, that meet both the prior to 1936 criterion, as at 10, and the new markets tax credit site criterion, as at 11. The invention next filters the building addresses found so far, as at 12, by states that have a historic tax credit or preservation program as at 13. The invention utilizes a computer that screens building addresses by state of situs and cross references that with a list of states of having the historic tax credit or preservation program. From the age, new market tax credit, and state credit screens, the present invention narrows the field of buildings to a manageable number as rehabilitation candidates.

Having found a set of buildings, the present invention also checks the is rehabilitation costs of those buildings. The invention, as at 20, estimates the total project costs for rehabilitating a building into a data center or other infrastructure facility. The estimates may begin as a dollar amount multiplied by the square footage of a building. As the invention narrows the set of buildings, the estimates may undergo refinement with more precision using actual construction costs for a particular building. Those actual costs may utilize existing construction estimating software. Qualifying for certain tax credits may guide the design of a facility and its cost estimation for without a qualified design, a facility would not be eligible for a tax credit as later described. Upon determining the costs for a project, typically one facility, the invention determines the qualifying rehabilitation expenses as at 21 per statutory guidelines of the various historic preservation programs at the federal and state levels. The present invention then multiplies the qualifying rehabilitation expenses by twenty percent and adds that amount to the qualifying rehabilitation expenses, as at 22. Alternatively, the present invention multiplies the qualifying rehabilitation expenses by 1.2 to arrive at a similar number. The preceding computerized search for a set of properties and determination of rehabilitation costs for those properties, projects, or facilities, prepares the properties to qualify for select tax credits.

Secondly, the present invention assembles various tax credits related to a project on a select site. The data center, facility, or building must qualify for the Federal Historic Preservation tax credit, a State Historic Preservation tax credit, and the New Markets tax credit, and have a site within a tax increment financing, or TIF, district qualifying for TIF financing, or any combination of one or more of the foregoing. Knowing the cost of a project and its position in a historic tax credit district, the present invention as at 30 obtains an allocation, or a reservation, of a State Historic Tax Credit following the State statutes that control for a particular project site. The cost of the project generally exceeds the state allocation so a developer has an incentive to seek out additional governmental credits. The invention then obtains a required allocation from a qualified community development enterprise, as at 31, as denoted by the Dept. of the Treasury. The developer and the project must meet the rules and regulations promulgated by the Treasury for this allocation. Once more, an allocation from a qualified community development enterprise may fall short of covering the project cost. When faced with that situation, the invention cultivates additional capital contribution, as at 32, such as from a tax increment financing loan, or TIF.

Having assembled the various tax credits, and optionally a TIF loan, the invention seeks to convert them into usable collateral for construction financing of data centers and the like. A project to rehabilitate a building has an ownership or operating structure, such as a company, and the various assembled tax credits. The invention then identifies and admits into the ownership or operating structure, or company, a third party, as at 40. The third party invests into the company with consideration, typically cash or cash equivalent, and receives in exchange an allocation of tax credits. These projects often include a lease term that exceeds the useful life of the rehabilitated building or project. Because of such a lengthy lease, the third party investor assumes and incurs an economic risk in the project. The third party investor makes its investment in the company and receives the required allocation before the “placed in service” date of a project in a manner that meets the requirements of 26 U.S.C. §47 and related rules and regulations. Also, the assembled tax credits appear attractive to third parties because one or more State Historic Preservation tax credits have portability in that, a holder of the credit may exchange, or sell, it to another owner, often between various corporations. The third party may be admitted as a shareholder or partner into an ownership structure of a company or alternatively as a lessee into an operating structure type of company. The investment by the third party provides funds in place of the tax credits. The invention then directs the funds, as at 41, to serve as collateral for financing of a construction project arranged as at 42 through at least one financing provider such as a bank, credit union, investment bank, and the like. With the financing in place, construction and rehabilitation of a historic structure may commence though the tenant for the reconstructed building has not yet appeared.

From the aforementioned description, a method to finance data centers and other high infrastructure facilities has been described. The method to finance data centers and other high infrastructure facilities is uniquely capable of creating collateral to bring a financing transaction to closure. The method of the invention utilizes a governmental right, a statutory reduction in tax, monetizes that right creating funds, and those funds serve as collateral for financing. The funds from the monetization of a governmental right apply financial leverage to bring about a rehabilitation project.

The method to finance data centers and other high infrastructure facilities and its various components may be may be written in many programming languages including but not limited to assembly, FORTRAN, BASIC, C, C++, Pascal, Visual Basic, HTML, JAVA, and XML and may be installed upon many computers including but not limited to mainframes, desktops, portable digital assistants, and networks.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A method to finance construction projects, such as data centers and other high infrastructure facilities, said method comprising:
creating for a project one of an ownership and an operating structure;
vetting suitable projects upon a computer;
assembling a plurality of select governmental rights held by said one of an ownership and an operating structure;
exchanging the select governmental rights upon said computer from said one of an ownership and an operating structure for an investment of funds by an investor; and,
forming capital from the investment funds of said exchanging the select governmental rights wherein a computer collateralizes financing of construction of a project using the capital.

2. The method to finance data centers of claim 1 further comprising:
said vetting including said computer identifying buildings constructed before 1936 from a database, said computer identifying buildings located in a district qualifying for a first select governmental right from a database, said computer identifying buildings located in a district qualifying for a second select governmental right from a database, said computer determining a cost of the construction project, said computer determining qualified rehabilitation expenses, and said computer applying a multiple to the qualified rehabilitation expenses.

3. The method to finance data centers of claim 1 further comprising:
said assembling including obtaining an allocation from a second governmental right, obtaining an allocation from a third governmental right, and arranging for tax increment financing.

4. The method to finance data centers of claim 1 further comprising:
said exchanging including finding an investor attracted to the plurality of select governmental rights and transferring funds from the investor to said one of an ownership and an operating structure in exchange for said select governmental rights.

5. The method to finance data centers of claim 1 wherein said governmental rights include federal historic preservation tax credit, state historic preservation tax credit, and the new markets tax credit.

6. A system to finance construction projects, such as data centers and other high infrastructure facilities, each of said projects owned by a company, said system comprising:
at least one computer connected to at least one storage device, a plurality of instructions stored in said at least one storage device, the plurality of instructions configured to cause said at least one computer to perform actions is further comprising:
vetting suitable projects upon said at least one computer, said vetting identifying buildings constructed before 1936 from a database, identifying buildings located in a qualifying district from a database, identifying buildings located in a second qualifying district from a database, determining a cost of the construction project, determining qualified rehabilitation expenses, and applying a multiple to the qualified rehabilitation expenses;
assembling a plurality of select governmental rights held by the company, said assembling including obtaining an allocation from a governmental right of the first qualifying district, obtaining an allocation from a governmental right of the second qualifying district, and arranging for tax increment financing;
exchanging the select governmental rights upon said computer by said company for an investment of funds by an investor, said exchanging including finding an investor attracted to the plurality of select governmental rights, and transferring funds from the investor to the company in exchange for said select governmental rights; and,
forming capital from the invested funds of said exchanging the select governmental rights wherein said at least one computer collateralizes financing of construction of a project using the capital.

7. The method to finance data centers of claim 6 wherein said governmental rights include federal historic preservation tax credit, state historic preservation tax credit, and new markets tax credit, and,
said exchanging the select governmental rights includes exchanging an ownership position in the company to the investor.

8. A system to finance construction projects, such as data centers and other high infrastructure facilities, each of said projects owned by a company, said system comprising:
at least one computer connected to at least one storage device;
a plurality of instructions stored in said at least one storage device, the plurality of instructions configured to cause said at least one computer to perform actions further comprising:
limiting the company to acquire suitable projects, vetting suitable projects upon said at least one computer, said vetting identifying buildings constructed before 1936 from a database, identifying buildings located in a qualifying district from a database, identifying buildings located in a second qualifying district from a database, determining a cost of the suitable project, determining qualified rehabilitation expenses, and applying a multiple to the qualified rehabilitation expenses;
assembling a plurality of select governmental rights held by said company, said assembling including obtaining an allocation from a governmental right of the first qualifying district, obtaining an allocation from a governmental right of the second qualifying district, and arranging for tax increment financing;
connecting the company by a network to said at least one computer and to at least one financing provider;
exchanging the select governmental rights and an ownership position in the company upon said at least one computer by the company for an investment of funds by an investor, said exchanging including finding an investor attracted to the plurality of select governmental rights, and transferring funds from the investor to the company;
forming capital from the invested funds of said exchanging the select governmental rights wherein said at least one computer collateralizes financing of construction of a project using the capital; and,
said governmental rights include federal historic preservation tax credit, state historic preservation tax credit, and new markets tax credit.
